(19) United States
(12) Patent Application Publication
(10) Pub. No.: US 2024/0051414 A1
(43) Pub. Date: Feb. 15, 2024

(54) POWER CONVERTER CONTROL IN AN ISOLATED POWER DOMAIN

(71) Applicant: Infineon technologies AG, Neubiberg (DE)

(72) Inventors: Ramdas Rangnath Ugale, Villach (AT); Mathiazhagan Eswaran, Pimpri Chinchwad (IN)

(21) Appl. No.: 18/366,982

(22) Filed: Aug. 8, 2023

(30) Foreign Application Priority Data
Aug. 9, 2022 (DE) 102022120031.0

(51) Int. Cl. B60L 53/22; B60L 58/10

(52) U.S. Cl. CPC B60L 53/22; B60L 58/10; B60L 2210/10

(57) ABSTRACT

In accordance with an embodiment, an electronic control unit (ECU) includes: a high voltage domain and a low voltage domain galvanically isolated from each other; a bus interface circuit in the low voltage domain; a controller in the high voltage domain, the controller being configured to receive data from and transmit data to the bus interface circuit; a first isolation device that couples the controller and the bus interface circuit; a DC/DC converter in the high voltage domain configured to receive a first battery voltage and configured to generate an output voltage therefrom for supplying the controller; and a second isolation device configured to receive an enable signal from a first circuit node in the low voltage domain and to provide the enable signal to the DC/DC converter in the high voltage domain.

This application claims the benefit of German Patent Application No. 102022120031.0, filed on Aug. 9, 2022, which application is hereby incorporated herein by reference.

### TECHNICAL FIELD

The present disclosure relates to controlling a power converter in an isolated power domain.

### BACKGROUND

In HV-ECUs a galvanic isolation is needed to supply voltage domains which operate with supply voltages above 60 volts. That is, an HV-ECU may include a high voltage (HV) domain and a low voltage (LV) domain, which are isolated from each other and connected via a galvanic isolation. To enable communication between the HV-ECU and other circuitry, a communication interface (usually a Controller Area Network, CAN, interface) may be arranged in the LV domain, whereas the vehicle's high voltage battery is coupled to the HV domain of the HV-ECU.

To support a galvanically isolated high baud rate communication between LV and HV domain, digital isolators are commonly used by circuit designers which usually include capacitors or coreless transformers to accomplish the galvanic isolation. Such digital isolators usually need isolated primary (low voltage domain) and secondary (high voltage domain) supplies to enable the communication. For this purpose, HV-ECUs usually include an embedded flyback switching converter to transfer power either from the LV domain to the HV domain, or vice versa, in order to provide primary and secondary supply for the digital isolators, which are needed for digital communication between HV and LV domains. Alternatively, a separate external switching converter can be used. However, the additional switching converter is relatively cost inefficient and there is a need for an improved concept that avoids the need for additional switching converters.

### SUMMARY

An ECU is described herein which, in accordance with one embodiment, may be used in a battery management system of an automobile. Accordingly, the ECU includes a high voltage domain and a low voltage domain which are galvanically isolated from each other. The ECU further includes a bus interface circuit in the low voltage domain and a controller in the high voltage domain. The controller is configured to receive data from and transmit data to the bus interface circuit via a first isolation device that couples the controller and the bus interface circuit. Furthermore, the ECU includes a DC/DC converter in the high voltage domain which is configured to receive a first battery voltage and to generate an output voltage therefrom for supplying the controller. Moreover, the ECU includes a second isolation device that is configured to receive an enable signal from a first circuit node in the low voltage domain and to provide it to the DC/DC converter in the high voltage domain. In another example, the ECU may be used to drive an inverter for driving an electric motor.

Another embodiment relates to a method for operating an ECU. The method includes receiving an enable signal at a first circuit node in the low voltage domain of an automotive ECU, while the ECU is operating in a Sleep Mode; transferring the enable signal—via an isolation device that couples the low voltage domain and a high voltage domain of the ECU—from the first circuit node to a DC/DC converter in the high voltage domain; enabling the DC/DC converter upon receiving the enable signal via the isolation device, so that the DC/DC converter generates an output voltage based on a battery voltage of a battery; and activating a controller of the ECU by (directly or indirectly) supplying the output voltage of the DC/DC converter to the controller thus leaving the Sleep Mode and resuming normal operation.

### BRIEF DESCRIPTION OF THE DRAWINGS

The invention can be better understood with reference to the following drawings and descriptions. The components in the figures are not necessarily to scale; instead emphasis is placed upon illustrating the principles of the invention. Moreover, in the figures, like reference numerals designate corresponding parts. In the drawings:

FIG. 1 illustrates one example of an ECU of a Battery Management System of an electric vehicle, wherein the ECU includes a Switched-Mode Power Supply (SMPS) to transfer power from the LV domain to the HV domain;

FIG. 2 illustrates one improved example of an ECU of a Battery Management System of an electric vehicle;

FIG. 3 illustrates an example of an ECU used to drive motor inverter used to control the operation of a brushless DC (BLDC) motor, a permanent magnet synchronous motor (PMSM) or the like; and

FIG. 4 illustrates an example of a method that may be performed by the ECUs of FIG. 2 or 3.

### DETAILED DESCRIPTION OF ILLUSTRATIVE EMBODIMENTS

Some embodiments of the present disclosure relates to the field of automotive High Voltage (HV) Electronic Control Units (ECUs) which may be used, for example, in Battery Management Systems (BMS), for driving inverters or the like.

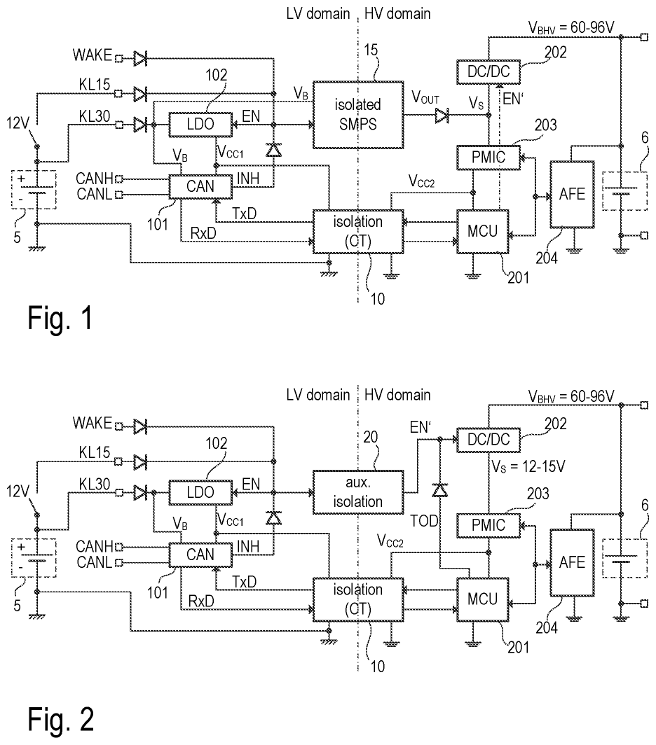

FIG. 1 illustrates one example of an ECU that may be part of a Battery Management System (BMS) of an electric vehicle or a plug-in hybrid electric vehicle. In the present example, the ECU includes a Switched-Mode Power Supply (SMPS) to transfer power from the LV domain to the HV domain.

Accordingly, the ECU includes terminals KL30 and KL15 for receiving a battery voltage V_{B} provided by a normal automotive battery 5 (e.g., V_{B}≈12V or 24V). The terminal KL15 is connected to the positive pole of the battery 5 via a switch (e.g., ignition switch) while the terminal KL30 is permanently connected the positive pole of the battery 5. In the present example, the ECU further has a terminal WAKE for receiving a wakeup signal that may be provided by an external controller or other external circuitry. Diodes may be connected to the terminals KL15, KL30 and WAKE (within the ECU external) to prevent reverse current flow. The voltage drop across these diodes (when forward biased) is not relevant for the present discussion and thus neglected. The voltage signal received at the terminal KL15 may also be regarded as (and used as) ignition-on signal, because it indicates whether the ignition switch is closed (i.e., the ignition is on). Also shown in FIG. 1 are the terminals CANH and CANL for connecting the ECU to a CAN network.

The ECU includes a voltage regulator 102 (labelled “LDO” in FIG. 1) which receives the battery voltage V_{B} from terminal KL30 (via the mentioned diode). The voltage regulator 102 is configured to generate a regulated voltage V_{CC1} (for example V_{CC1}=5V) from the battery voltage V_{B}. The voltage V_{CC1} provided by the voltage regulator 102 is used as a supply voltage for a bus interface 101 and as a primary supply voltage for an isolation device 10, which may be a digital isolator 10.

The bus interface 101, which is a CAN driver in the present example, also receives the battery voltage V_{B} (via terminal KL30) and is connected to the bus terminals CANH and CANL. The CAN driver 101 is configured to output data, which is received from the CAN network at the bus terminals CANH and CANL, at the output TxD of the CAN driver 101. Similarly, the CAN driver 101 is configured to transmit data, which is received at the input TxD of the CAN driver 102, to the CAN network via the bus terminals CANH and CANL. In the present example, the CAN driver 101 is configured to indicate, via a High level at the INH output of the CAN driver 101, when data is received from or sent to the CAN network. It is understood that other bus standards (FlexRay, Ethernet fieldbus, etc.) may be used dependent on the actual implementation. The signal provided at the INH output of the CAN driver 101 can be regarded as status signal indicating a bus activity, e.g. that data is received at the bus terminals CANH and CANL. In a generic example, the INH output is a status output of the bus interface which provides a status signal.

The digital isolator 10 is connected to the RxD output and the TxD input of the CAN driver 101 and configured to transfer incoming and outgoing data across a galvanic isolation barrier that separates the LV domain from the HV domain. The galvanic isolation barrier may be, for example, realized using an integrated coreless transformer or integrated capacitors. Suitable digital isolators as well as suitable CAN drivers are as such known and commercially available and are thus not further discussed herein in more detail.

The ECU of FIG. 1 also includes an SMPS 15, which is connected (via the diode) to terminal KL30 to receive the battery voltage V_{B} and configured to generate, from the battery voltage V_{B}, an auxiliary supply voltage V_{OUT} for some circuitry in the HV domain. The purpose and the use of the auxiliary supply voltage V_{OUT} will be discussed further below in more detail. As shown in FIG. 1, the SMPS 15 has an enable input to receive an enable signal EN. That is the SMPS 15 is activated or deactivated dependent on the logic level (High level or Low Level, respectively) of the enable signal EN. In the present example, the enable signal is at a High level (to activate the SMPS) if one of the following three conditions is fulfilled: (1) the ignition switch is closed and thus the battery voltage V_{B} is not only received at terminal KL30 but also at terminal KL15; (2) a wakeup command is received at the terminal WAKEUP; and (3) the CAN driver 101 signals activity on the CAN bus terminals CANL and CANH at its INH output.

A skilled person will appreciate that this or-conjunction is practically realized by the diodes connected between the enable input of the SMPS 15 and each one of the terminals KL15, WAKEUP and INH. It is understood that the same function (or-conjunction) may be achieved using different circuit components such as, for example and or-gate. In some applications, a separate WAKEUP terminal and/or KL15 terminal may be not needed and thus can be omitted.

In the example of FIG. 1, the HV domain includes a controller 201 (labelled MCU in the figures), which is coupled, via the digital isolator 10, to the CAN driver 101. That is, the controller 201 is configured to communicate with external (i.e., outside the ECU) circuitry via the CAN bus. Accordingly, incoming data, received from the CAN bus is forwarded to the controller 201 by the CAN driver 101 and via the digital isolator 10. Similarly, outgoing data is transmitted, from the controller 201 and via the digital isolator 10, to the CAN driver 101, which outputs the data on the CAN bus lines connected to bus terminals CANH and CANL.

In the examples described herein, the controller 201 may be a microcontroller, which includes a processor and memory that includes software instructions that are, during operation, executed by the processor. The controller 201 may also include peripheral circuitry configured to input and output data in order to communicate with other circuit components. Accordingly, the processor—with the help of the peripheral circuitry—can receive data from and send data to the CAN driver 101 and other circuit components. However, the controller 201 does not necessarily have to include a processor for executing software instructions. In some embodiments, the controller 201 may include hard-wired logic circuits or one-time programmable circuitry. Alternatively, the function of the controller may be partly provided by a processor executing software instructions and partly by hard-wired logic circuits.

The microcontroller 201, like the secondary side of the digital isolator 10, is supplied with the supply voltage V_{CC22}. In the depicted example, the supply voltage V_{CC2} is provided by a supply circuit 203 which may also be referred to as power management Integrated Circuit (PMIC). In the examples described herein, the supply circuit is basically a voltage regulator that generates a regulated supply voltage for the microcontroller (and other circuitry in the HV domain). During normal operation, the input voltage V_{S} of the voltage regulator 203 is generated, by a DC/DC converter 202, based on the batty voltage V_{BHV} of the vehicle's HV battery 6 that is coupled to the ECU. For example, a typical value for the voltage V_{S} is 12-15 V, wherein the supply voltage V_{CC2} may be, e.g., 5 V or less. In the present example, the microcontroller 201 communicates with the analog frontend (AFE) 204 of the battery management system (BMS). The analog frontend 204 is coupled to the HV battery 6 and may also be supplied by the HV battery 6. In some applications, the analog frontend may communicate (exchange data) with the PMIC 203.

In an alternative example, the supply circuit 203 may be omitted and the microcontroller 201 as well as further components in the HV domain may be supplied directly by the DC/DC converter output voltage V_{S}. It is understood that, in some embodiments different supply circuits may be used to generate different regulates supply voltages from the DC/DC converter output voltage V_{S}, while some components may be supplied directly by the DC/DC converter.

The ECU may transition into a Sleep Mode, in which most of the circuitry in the HV domain is inactive, particularly the DC/DC converter 202 and the microcontroller 201. Sleep Mode may also be referred to as Idle Mode or Standby Mode; it is commonly used to reduce the power consumption of the vehicle while the vehicle is parked and off in order to keep the discharging of the HV battery low. In practice, the circuitry in the HV domain of the ECU is required to wakeup (i.e., leave the Sleep Mode and resume Normal Mode operation) in response to certain events occurring in the LV domain, for example upon receiving data from the CAN bus. However, during Sleep Mode, the DC/DC converter 202 and the microcontroller 201 in the HV domain are inactive and thus the supply voltage V_{S} would be zero without further measures.

The wakeup of the DC/DC converter 202 is usually triggered by the MCU 201. However, the microcontroller 201 needs to be active to be able to wakeup the DC/DC converter 202. Therefore, the voltage regulator/PMIC 203 is also coupled, via a diode, to the output of the isolating SMPS 15 so that the SMPS (output voltage V_{OUT}) can supply the voltage regulator/PMIC 203 when the DC/DC converter 202 is in Sleep Mode. Accordingly, the voltage regulator can generate the supply voltage V_{CC2} for the microcontroller 201 and the digital isolator 10 during Sleep Mode (but when a wakeup is required) thus enabling the microcontroller to wakeup the DC/DC converter 202.

In the example of FIG. 1, a wakeup of the circuitry in the HV domain is triggered as follows. In the LV domain, the enable signal EN transitions from a Low level to a High Level in response to one of the following events: the ignition switch is closed and thus the battery voltage V_{B} is applied at 1 KL15; (2) a wakeup command (e.g., a High Level) is received at the terminal WAKEUP; and (3) the INH output of the CAN driver 101 signals activity on the CAN bus terminals CANL and CANH by setting the INH signal to a High Level. A High Level of the enable signal EN activates the SMPS 15 which then generates an output signal V_{OUT} based on the battery voltage V_{B}. When the DC/DC converter 202 in the HV domain is in Sleep Mode (and thus its output voltage V_{S} is zero), the voltage V_{OUT} generated by the SMPS 15 pulls the input node of the voltage regulator 203 to a voltage level (e.g., V_{S} minus the forward voltage of a diode) which is sufficiently high to enable the voltage regulator/PMIC 203 to output the supply voltage V_{CC2} to the microcontroller 201 and the digital isolator 10, thus activating the microcontroller 201 and enabling the communication channel between the microcontroller 201 and the CAN bus.

Once the microcontroller is active and operating in Normal Mode, the DC/DC converter 202 can be enabled by the microcontroller 201 and the output voltage V_{S} of the OC/DC converter 202 may replace the output voltage of the SMPS 15. In the example of FIG. 1, the diode arranged between the SMPS 15 and the voltage regulator 203 is non-conductive if the difference V_{OUT}-V_{S} is less than the forward voltage of a diode (e.g., ≈0.6 V).

An isolating SMPS topology (such as, e.g., a flyback converter) is capable of transferring power across the isolation barrier between LV domain and HV domain (without requiring a supply on the HV side). In contrast thereto, digital isolators 10 are not capable of transferring significant power, require a separate supply voltage at the primary (LV) and secondary (HV) side, and can only transfer digital data (bitwise). The additional SPMS 15 increases the number of discrete circuit components and also increases the cost of the overall system.

In an alternative approach, the LV domain is not supplied by a separate battery (i.e., battery 5 is omitted), with the consequence that the SMPS 15 is “reversed”, i.e. provides a supply voltage V_{B} for the circuitry in the LV domain based on the output voltage V_{S} generated by the DC/DC converter 202 in the HV domain. However, also in this approach the additional SMPS 15 is needed, and it needs to be always active as otherwise a wakeup of the HV domain would not be possible in response to, e.g., a CAN bus activity due to incoming data.

The example of FIG. 2 is an ECU which does not need the additional SMPS 15 while still while still being able to operate in Sleep Mode and to trigger a wakeup of the HV domain in response to a detected bus activity due to incoming data.

The circuits in FIG. 1 and FIG. 2 are largely the same, which is why only the differences between FIG. 2 and FIG. 1 will be discussed below. With regard to the LV domain, the circuits of FIGS. 1 and 2 are, in essence, identical except that the SMPS 15 (which couples LV and HV domain) is replaced by an additional (auxiliary) isolation device 20, which may also be a digital isolator. The isolation device 20 may be of the same type as the isolation device 10, wherein the isolation device 20 needs only one channel from the LV domain to the HV domain (forward channel); a second channel (backward channel) is not needed. Both isolation devices may include an integrated coreless transformer, an integrated capacitor or an opto-coupler to provide the galvanic isolation. Of course, the isolation devices 10 and 20 may be of the same or of different type.

With regard to the HV domain the circuits of FIGS. 1 and 2 are, in essence, identical except that the DC/DC converter, when operating in Sleep Mode, can be woken up by the enable signal EN, which is transferred from the LV domain to the HV domain by the digital isolator 20. In the HV domain, the enable signal is labelled EN′. Therefore, a wakeup event occurring in the LV domain (e.g., a bus activity on the CAN bus, a switch-on of the ignition switch or a wakeup command received at the WAKEUP terminal) can be communicated to the HV domain and thus activate the DC/DC converter 202.

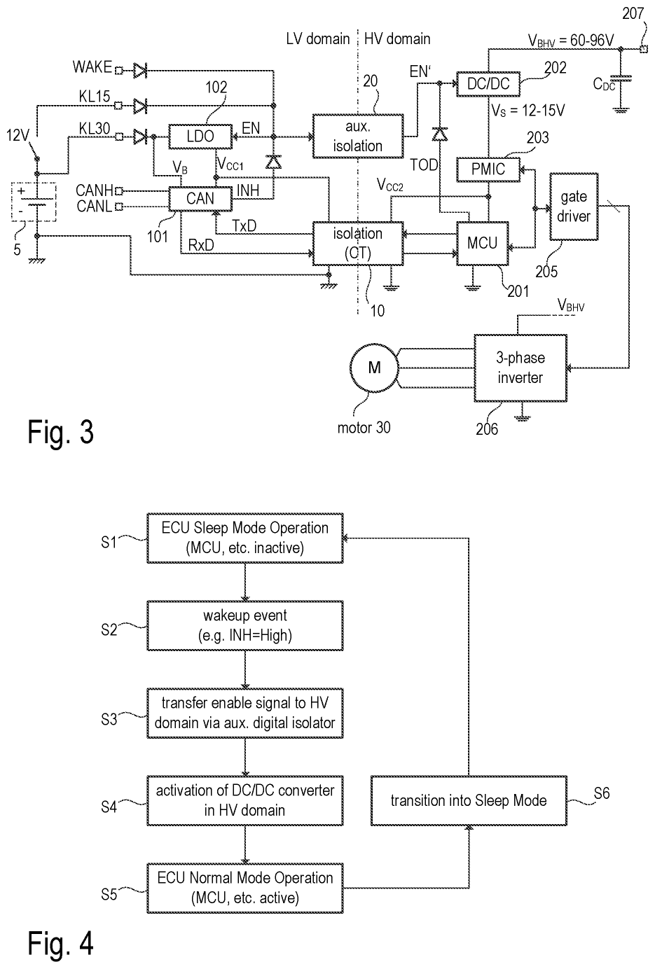

In the example of FIG. 2, the microcontroller 201 is not responsible for triggering the wakeup of the DC/DC converter 202. However, the microcontroller 202 is capable of delaying the transition into the Sleep Mode by delaying the deactivation of the DC/DC converter 202 in a situation, in which the enable signal EN transitions to a Low Level in the LV domain (indicating Sleep Mode). This delay may be, for example, accomplished by the microcontroller 201 pulling the enable input of the DC/DC converter 202 to a High Level (of signal TOD, see FIG. 3), which keeps the DC/DC converter 202 active. For this purpose, a digital output of the microcontroller 201 may be connected to the enable input of the DC/DC converter 202 via a diode. A skilled person will understand that, alternatively, the enable signal EN′ and the mentioned digital output of the microcontroller 201 may be combined using an or-gate. To enter Sleep Mode, the microcontroller 201 can set the signal level at the mentioned digital output to a Low Level to finally disable the DC/DC converter 202.

In the example of FIG. 2, the CAN driver, the LDO 102 and the digital isolator 10 operate basically in the same way as discussed above with reference to FIG. 1. Also, the voltage regulator/PMIC 203, the micro controller 201 and the analog frontend 204 in the HV domain operate basically in the same way as in the previous example and reference is made to the respective description above. It is understood, that the AFE 203 is not only coupled to the battery terminals of the HV battery 6 but may also be coupled to the individual battery cells in order to enable a monitoring of the cell voltages, determining State of Charge (SoC), etc. Analog frontend circuitry for battery management systems is as such known and commercially available and is thus not discussed herein in more detail.

The concept underlying the ECU design of FIG. 2 can not only be used in connection with a battery management system of an electric vehicle or a plug-in hybrid electric vehicle, but also in connection with an inverter used to control the operation of an electric motor of an electric vehicle or a plug-in hybrid electric vehicle. FIG. 3 illustrates an example. The circuit of FIG. 3 is basically identical with the circuit of FIG. 2 except that the analog frontend 204 of the BMS (cf. FIG. 2) has been replaced by the gate driver 205, which is configured to generate—dependent on control signals/commands received from the microcontroller 201—gate signals for a motor inverter 206.

In the present example, the motor inverter 206 is a three-phase power inverter which includes three transistor half-bridges each composed of two power MOSFETs (metal-on-semiconductor field-effect transistors) or IGBTs (insulated gate bipolar transistors). The output nodes of the three transistor half-bridges for the three phases of a three-phase alternating current system. The three phases are connected to a suitable electric motor, e.g. a BLDC motor, a PMSM or the like. Suitable gate-drivers and inverters are as such known and commercially available and are thus not further discussed herein. The HV battery 6 has been omitted in FIG. 6 just to keep the drawing simple, Nevertheless, a HV battery may be connected to the terminal 207 similar to the previous example.

Apart from the gate driver and the inverter, the example of FIG. 3 is the same as FIG. 2 and reference is made to the respective description above. It is understood that the microcontroller will need different software in the examples of FIGS. 2 and 3. However, as mentioned, battery management systems and gate drivers for motor inverters are as such known and, therefore, the specific functions of the microcontroller 202 is not discussed in more detail herein.

FIG. 4 illustrates an example of a method that may be performed by the ECUs of FIG. 2 or 3. More particularly, FIG. 4 illustrates a method illustrating how an ECU of a BMS or an ECO for the motor inverter control may transition from Sleep Mode to Normal Mode (wakeup) in response to a wakeup event occurring in the LV domain of the ECU.

The flow chart of FIG. 4 starts in a situation, in which the ECU operates in Sleep Mode (see FIG. 4, box S1), i.e. the DC/DC converter 201 in the HV domain is inactive and thus the microcontroller 201 and the secondary side of the digital isolator 201 has no supply. A wakeup event in the LV domain is indicated by the enable signal EN (see FIG. 4, box S2). For example, the enable signal EN may signal the wakeup event by changing from a low signal level to a high signal level. The enable signal EN is transferred—via the isolation device 20 from the LV domain to the DC/DC converter 202 in the HV domain (see FIG. 4, box S3). As a consequence, the DC/DC converter 202 is enabled upon receiving the enable signal via the isolation device 20, so that the DC/DC converter generates an output voltage V_{S} based on a battery voltage V_{BHV} of the vehicle's HV-battery 6 (see FIG. 4, box S4). As a result, the controller 201 of the ECU is activated as it as it now is (directly or indirectly) supplied by the output voltage V_{S} of the DC/DC converter (202). Accordingly, the microcontroller 201 leaves the Sleep Mode and resumes normal operation (Normal Mode, see FIG. 4, box S5).

The ECU may again transition into Sleep Mode (see FIG. 6, box S6) by deactivating the DC/DC converter 202 (and thus deactivating the supply of the microcontroller) in response to the enable signal EN signaling end of Normal Operation (e.g., enable signal changing from a High level to a Low level). As mentioned above, in one embodiment, the microcontroller of the ECU is capable of delaying the transition into the Sleep Mode by delaying the deactivation of the DC/DC converter 202 in a situation, in which the enable signal EN transitions to a Low Level in the LV domain (indicating Sleep Mode). This delay may be, for example, accomplished by the microcontroller pulling the enable input of the DC/DC converter 202 to a High Level (cf. FIG. 2, signal TOD), which keeps the DC/DC converter 202 active as long as the TOD signal is at a High Level.

It is understood that the terms “High level” and “Low level” relate to the voltage or current levels of logic signals. Usually, a Low level is defined as a voltage below a defined first threshold (e.g., below 0.8V, e.g. approx. 0V), whereas a High level is defined as a voltage above a defined threshold (e.g., 2.4 V, e.g. approx. 5V). Dependent on the specific implementation a Low level may indicate a logical o while a High level indicates a logical 1. The mentioned voltage values are merely an example and may be different dependent on the actual implementation and the technology used to implement logic circuits.

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

What is claimed is:

1. An electronic control unit (ECU), the ECU comprising:
a high voltage domain and a low voltage domain galvanically isolated from each other;
a bus interface circuit in the low voltage domain;
a controller in the high voltage domain, the controller being configured to receive data from and transmit data to the bus interface circuit,
a first isolation device that couples the controller and the bus interface circuit;
a DC/DC converter in the high voltage domain configured to receive a first battery voltage and configured to generate an output voltage therefrom for supplying the controller; and
a second isolation device configured to receive an enable signal from a first circuit node in the low voltage domain and to provide the enable signal to the DC/DC converter in the high voltage domain.

2. The ECU of claim 1 further comprising a supply circuit configured to provide a regulated supply voltage for the controller from the output voltage of the DC/DC converter.

3. The ECU of claim 1, further comprising circuitry configured to set the enable signal to a first level, wherein:
setting the enable signal to the first level is configured to trigger enabling the DC/DC converter;
setting the enable signal to the first level is based on at least one of: a wakeup signal, an ignition-on signal of a vehicle, or a status signal; and
the bus interface circuit is configured to assert the status signal upon receiving data.

4. The ECU of claim 3, wherein the first circuit node is connected, via a diode, to a terminal configured to receive the wakeup signal.

5. The ECU of claim 3, wherein the first circuit node is connected, via a diode, to a terminal configured to receive the ignition-on signal.

6. The ECU of claim 3, wherein the first circuit node is connected, via a diode, to a status output of the bus interface, wherein the status output is configured to indicate bus activity.

7. The ECU of claim 1, wherein the second isolation device is configured to transfer digital signals from the low voltage domain to the high voltage domain.

8. The ECU of claim 7, wherein:
the second isolation device includes an integrated coreless transformer, an integrated capacitor or an integrated opto-coupler; and
the second isolation device is not configured to provide a supply voltage for supplying circuitry in the high voltage domain.

9. The ECU of claim 1, wherein the first isolation device includes an integrated coreless transformer, an integrated capacitor or an integrated opto-coupler.

10. An automotive battery management system comprising:
a battery; and
the ECU of claim 1, wherein the ECU further includes a battery management circuit coupled to the battery and configured to communicate with the controller.

11. A system for controlling an electric motor of a vehicle, the system comprising:
the ECU of claim 1, wherein the ECU further includes a gate driver circuit coupled to an inverter and configured to communicate with the controller.

12. A method comprising:
receiving an enable signal at a first circuit node in a low voltage domain of an automotive ECU, while the ECU is operating in a Sleep Mode;
transferring the enable signal, via an isolation device that couples the low voltage domain and a high voltage domain of the ECU, from the first circuit node to a DC/DC converter in the high voltage domain;
enabling the DC/DC converter upon receiving the enable signal via the isolation device, so that the DC/DC converter generates an output voltage based on a battery voltage of a battery; and
activating a controller of the ECU by supplying the output voltage of the DC/DC converter to the controller; wherein activating the controller of the ECU causes the ECU to leave the Sleep Mode and resume normal operation.

13. The method of claim 12, further comprising, during normal operation:
receiving data from a bus via a bus interface; and
transferring the received data to the controller via a further isolation device.

14. The method of claim 12, further comprising entering Sleep Mode by deactivating the DC/DC converter in response to the enable signal signaling an end of normal operation.

15. The method of claim 14, wherein the controller is configured to delay the deactivation of the DC/DC converter.

16. An electronic circuit comprising:
a first power domain comprising a bus interface circuit;
a second power domain galvanically isolated from the first power domain and comprising:
a controller coupled to the bus interface circuit via a first isolation device, and
a power converter comprising a power output coupled to a power supply input of the controller, and an enable signal input coupled to a first node in the first power domain via a second isolation device.

17. The circuit of claim 16, wherein the second power domain further comprises a voltage regulator coupled between the power output of the power converter and the power supply input of the controller.

18. The circuit of claim 16, wherein the first power supply domain further comprises an ORing circuit having;
a first input coupled to a wakeup signal input;
a second input coupled to a vehicle ignition-on signal input;
a third input coupled to a status output of the bus interface circuit; and
an OR output coupled to the first node.

19. The circuit of claim 18, wherein the ORing circuit comprises:
a first diode coupled between the first input and the OR output;
a second diode coupled between the second input and the OR output; and
a third diode coupled between the third input and the OR output.

20. The circuit of claim 16, wherein a power supply voltage of the first power domain is lower than a power supply voltage of the second power domain.
